(19) United States
(12) Patent Application Publication
(10) Pub. No.: US 2026/0279236 A1
(43) Pub. Date: Sep. 17, 2026

(54) DISPLAY DEVICE AND ELECTRONIC DEVICE

(71) Applicant: SAMSUNG DISPLAY CO., LTD., YONGIN-SI (KR)

(72) Inventors: DAE-GWANG JANG, Yongin-si (KR); SEUNGJAE LEE, Yongin-si (KR); KYUNGSU LEE, Yongin-si (KR); KUK-HWAN AHN, Yongin-si (KR)

(21) Appl. No.: 19/564,367

(22) Filed: Mar. 12, 2026

(30) Foreign Application Priority Data
Mar. 13, 2025 (KR) 10-2025-0032852
May 23, 2025 (KR) 10-2025-0067582

(51) Int. Cl. G09G 3/00; G09G 3/32; G09G 3/3266; G09G 3/3275

(52) U.S. Cl. CPC G09G 3/006; G09G 3/32; G09G 3/3266; G09G 3/3275; G09G 2310/0267; G09G 2310/0275; G09G 2310/061; G09G 2330/028; G09G 2330/12

(57) ABSTRACT

A display device includes a display panel, a scan driving circuit, a data driving circuit, and a sensing circuit. The display panel includes a plurality of pixels. The data driving circuit is configured to provide image data and pattern data to the pixels. The sensing circuit is configured to provide a reference voltage to the pixels and generate sensing data by accumulating a sensing current corresponding to the pattern data. The sensing circuit includes a reference voltage generator, an integrator, and an analog-to-digital converter. The reference voltage generator is configured to provide a reference voltage to the pixels during an active period. The integrator is configured to receive a sensing current corresponding to the pattern data during a blank period. The analog-to-digital converter is configured to convert a voltage provided from the integrator into sensing data.

### CROSS-REFERENCE TO RELATED APPLICATIONS

This application claims priority to and the benefit of Korean Patent Application Nos. 10-2025-0032852 and 10-2025-0067582 under 35 U.S.C. § 119, filed on Mar. 13, 2025, and May 23, 2025, respectively, in the Korean Intellectual Property Office, the contents of which are incorporated by reference herein in their entirety.

### Technical Field

The present disclosure relates to a display device and an electronic device. Particularly, the present disclosure relates to a display device and an electronic device configured to detect electrical characteristics of a pixel.

### Discussion of the Related Art

A display device includes a plurality of pixels, and scan lines, emission control lines, and data lines connected to the plurality of pixels. Each pixel may include an organic light-emitting diode, and a driving transistor configured to control an amount of current flowing through the organic light-emitting diode. The pixel may emit light of selectable luminance by supplying a current from the driving transistor to the organic light-emitting diode based on a data signal provided through the data line.

Electrical characteristics of a pixel, such as threshold voltage and carrier mobility of the driving transistor, may vary due to process variations and the degree of pixel degradation. To detect and compensate for such variations, a sensing circuit may be configured to sense electrical characteristics of pixels by measuring a sensing voltage based on a sensing current of the pixels.

### SUMMARY

The present disclosure provides a display device and electronic device capable of detecting electrical characteristics of a pixel with high accuracy through a sensing circuit having an integrator structure.

A display device according to one embodiment of the present disclosure includes a driving controller configured to provide a data signal, a display panel including a plurality of pixels connected to a scan line, a data line, and a sensing line, a scan driving circuit configured to provide a scan signal to the plurality of pixels through the scan line, a data driving circuit configured to generate image data based on the data signal and pattern data, and provide the image data and the pattern data to the plurality of pixels through the data line, and a sensing circuit configured to provide a reference voltage to the plurality of pixels through the sensing line, generate sensing data by accumulating a sensing current corresponding to the pattern data based on the reference voltage, and transmit the sensing data to the driving controller. The sensing circuit comprises a reference voltage generator configured to provide the reference voltage to the plurality of pixels through the sensing line during an active period in which an image is displayed, an integrator configured to receive the sensing current corresponding to the pattern data through the sensing line during a blank period subsequent to the active period, and to output a sensing voltage by accumulating the sensing current, and an analog-to-digital converter configured to convert the sensing voltage into the sensing data.

In one embodiment, the driving controller is further configured to generate the data signal based on image signal received from an external device and the sensing data received from the sensing circuit.

In one embodiment, the sensing circuit further comprises a driving switch connected between the sensing line and the reference voltage generator, and configured to be turned on during the active period, and a sensing switch connected between the sensing line and the integrator, and configured to be turned on during the blank period.

In one embodiment, the integrator includes an amplifier, in which a first input terminal of the amplifier is electrically connected to the sensing line, a second input terminal of the amplifier is electrically connected to the reference voltage generator and receives the reference voltage, and an output terminal of the amplifier is configured to output the sensing voltage, and a feedback capacitor electrically connected between the first input terminal of the amplifier and the output terminal of the amplifier, thereby converting the sensing current into the sensing voltage.

In one embodiment, the sensing circuit further comprises a reset switch connected between the first input terminal of the amplifier and the output terminal of the amplifier, and the reset switch is configured to be turned on to initialize the feedback capacitor after the sensing voltage is converted into the sensing data.

In one embodiment, the sensing circuit further includes a sensing capacitor electrically connected between an input terminal of the analog-to-digital converter and a ground power source; and configured to accumulate the sensing current during the blank period, and an auxiliary switch connected between the sensing switch and the sensing capacitor, and configured to be turned on to transfer the sensing current to the sensing capacitor.

In one embodiment, the display panel further includes a driving switch connected between the sensing line and the reference voltage generator, and configured to be turned on during the active period, and a sensing switch connected between the sensing line and the integrator, and configured to be turned on during the blank period.

In one embodiment, the plurality of pixels are arranged in a plurality of pixel blocks, each of the plurality of pixel blocks comprises a target pixel row connected to the sensing line and non-target pixel rows that are not connected to the sensing line, and a number of the sensing line is less than a number of the scan line.

In one embodiment, the pattern data comprises a first data signal to be applied to a target pixel of the target pixel row, and a second data signal to be applied to pixels of the target pixel row other than the target pixel, wherein the first data signal has a greater gray value than the second data signal.

A display device according to one embodiment of the present disclosure includes a plurality of first pixels connected to a scan line, a data line, and a sensing line, a plurality of second pixels connected to the scan line and the data line, and not connected to the sensing line, a scan driving circuit configured to provide a scan signal to the plurality of first pixels and the plurality of second pixels through the scan line, a data driving circuit configured to provide pattern data to the plurality of first pixels and provide image data to the plurality of first pixels and the plurality of second pixels through the data line, and a sensing circuit configured to provide a reference voltage to the plurality of first pixels through the sensing line and generate sensing data by accumulating sensing current corresponding to the pattern data based on the reference voltage. The data driving circuit is configured to operate on a frame-by-frame basis, provide image data during an active period of each frame in which an image is displayed, and provide pattern data during a blank period subsequent to the active period.

In one embodiment, the plurality of first pixels are arranged in a target pixel row, and each target pixel is selected from the target pixel row.

In one embodiment, the pattern data may include a first data signal which is applied to a target pixel of the target pixel row, and a second data signal which is applied to a plurality of first pixels of the target pixel row other than the target pixel, wherein the first data signal has a greater gray value than the second data signal.

In one embodiment, the target pixel is arranged in different column location of the target pixel row for each blank period.

In one embodiment, a first frame includes a first active period and a first blank period, a second frame subsequent to the first frame comprises a second active period and a second blank period, wherein the pattern data comprises a first data signal applied to the target pixel during the first blank period and a second data signal applied to the plurality of first pixels of the target pixel row other than the target pixel during the first blank period, and to the plurality of first pixels of the target pixel row, including the target pixel during the second blank period. The first data signal has a greater gray value than the second data signal.

In one embodiment, a third frame subsequent to the second frame includes a third active period and a third blank period, and a fourth frame subsequent to the third frame comprises a fourth active period and a fourth blank period. The pattern data further includes a third data signal to be applied to a second target pixel during the third blank period, and the second data signal is applied to the plurality of first pixels other than the second target pixel during the third blank period, and to the plurality of first pixels including the target pixel during the fourth blank period. The third data signal has a greater gray value than the second data signal, and the second target pixel selected during the third blank period is disposed in different column location of the target pixel row from a column location of the target pixel selected during the first blank period.

In one embodiment, the blank period includes a first sub-period and a second sub-period, and the pattern data includes a first data signal to be applied to a target pixel during the first sub-period, and a second data signal to be applied to the plurality of first pixels other than the target pixel during the first sub-period, and to the plurality of first pixels of the target pixel row including the target pixel during the second sub-period. The first data signal has a greater gray value than the second data signal.

In one embodiment, the second sub-period follows the first sub-period, and the target pixel is disposed in different column location of the target pixel row for each first sub-period .

In one embodiment, the first sub-period follows the second sub-period, and the target pixel is disposed in different column location of the target pixel row for each first sub-period.

An electronic device according to one embodiment of the present disclosure includes a processor configured to provide an image signal and a control signal and a display module including a driving controller configured to receive the image signal and the control signal, and generate a data signal based on the image signal, and generate a scan control signal, a light-emission driving control signal, a data control signal, and a sensing control signal based on the control signal, a display panel including a plurality of pixels connected to a scan line, a data line, and a sensing line, a scan driving circuit configured to provide a scan signal to the plurality of pixels through the scan line in response to the scan control signal, a data driving circuit configured to provide image data and pattern data to the plurality of pixels through the data line in response to the data control signal, and a sensing circuit configured to provide a reference voltage to the plurality of pixels through the sensing line and generate sensing data by accumulating a sensing current corresponding to the pattern data in response to the sensing control signal. The sensing circuit includes a reference voltage generator configured to provide the reference voltage to the plurality of pixels through the sensing line during an active period in which an image is displayed on the display panel, an integrator configured to receive the sensing current corresponding to the pattern data through the sensing line during a blank period subsequent to the active period, and generate a sensing voltage based on the sensing current, and an analog-to-digital converter configured to convert the sensing voltage into the sensing data.

In one embodiment, the processor is further configured to receive the sensing data and adjust the image signal based on the sensing data.

In one embodiment, the electronic device may further include a processor, a memory, and a power module. The processor may be configured to execute an application to transfer an image data signal to the display module. The memory may be configured to store data information for executing the application. The power module may be configured to provide power to the display module, the processor, and the memory. The display module may be configured to output image information based on the image data signal.

According to one embodiment of the present disclosure, sensing accuracy may be improved by accumulating and outputting a sensing current transferred from a pixel through an integrator.

In addition, according to one embodiment of the present disclosure, a reference value of sensing data may be measured by applying pattern data having black gray value.

### BRIEF DESCRIPTION OF THE DRAWINGS

These and/or other features will become apparent and more readily appreciated from the following description of the embodiments, taken in conjunction with the accompanying drawings in which:

FIG. 1 illustrates a block diagram of a display device according to one embodiment of the present disclosure;

FIG. 2 illustrates a connection structure of the display panel and the driving circuits shown in FIG. 1;

FIG. 3 is an exemplary block diagram of the display panel shown in FIG. 2;

FIG. 4 illustrates a pixel block shown in FIG. 3;

FIG. 5 illustrates a pixel according to one embodiment of the present disclosure;

FIG. 6 illustrates an equivalent circuit of a pixel and a sensing circuit according to one embodiment of the present disclosure;

FIG. 7 is a timing diagram illustrating an operation of a sensing circuit according to an embodiment;

FIG. 8 is a timing diagram illustrating an operation of a sensing circuit in a blank period;

FIG. 9 illustrates pattern data applied to a pixel during a blank period;

FIGS. 10A and 10B illustrate pattern data applied to a pixel during a blank period according to an embodiment;

FIG. 11 is a timing diagram illustrating an operation of a sensing circuit according to an embodiment;

FIGS. 12A and 12B illustrate pattern data applied to a pixel based on the operation of the sensing circuit shown in FIG. 11;

FIG. 13 is a block diagram of an electronic device to which a display device according to one embodiment of the present disclosure is applied; and

FIG. 14 illustrates electronic devices according to embodiments of the present disclosure.

### DETAILED DESCRIPTION

References will now be made in detail to certain embodiments, examples of which are illustrated in the accompanying drawings, in which like reference numerals refer to like elements throughout. The embodiments may take various forms and permutations, but the present disclosure shall not be construed as being limited to the embodiments described herein. Rather, the present disclosure shall be construed to encompass all forms, permutations, equivalents and substitutes covered by the technical ideas and scope of the present disclosure. Accordingly, the embodiments are merely described below, with reference to the figures, to explain features of the present disclosure.

In the accompanying drawings, the thicknesses, ratios, and dimensions of the elements may not be drawn to exact scale and may have been exaggerated for purposes of clearly illustrating the technical features associated with these elements. Accordingly, the present disclosure shall not be limited to the thicknesses, ratios, dimensions, and the like illustrated in the drawings. The term “and/or” encompasses all possible combinations of the associated elements as defined herein.

An expression such as “comprising” or “including” is intended to designate a characteristic, a number, a step, an operation, an element, a part or combinations thereof, and shall not be construed to preclude the presence or addition of one or more other characteristics, numbers, steps, operations, elements, parts or combinations thereof.

Terms such as “first” and “second” may be used to describe various elements, but the elements shall not be limited by these terms. These terms are used only to distinguish one element from another. For example, the first element may be referred to as the second element, and vice versa, without departing from the scope of claims of the present disclosure. Unless clearly indicated otherwise, expressions in the singular form may include the plural form.

In the present disclosure, being electrically connected includes being physically or directly connected as well as being selectively connected through a switching device even when not physically connected. The switching device may be a transistor integrated into a display device, and include a gate terminal (gate electrode), an input terminal (input electrode), and an output terminal (output electrode).

A display device includes a display panel, a data driving circuit, and a sensing circuit, in which the display panel includes a plurality of pixels. Electrical characteristics of each pixel may vary depending on the location of the pixel in the display panel, ambient temperature, and heat generated in the display panel. By providing pattern data to a pixel during a blank period, the sensing circuit may sense a sensing current corresponding to the pattern data and generate sensing data based on the sensing current. The display device may adjust value of image data supplied to the pixel based the sensing data, thereby compensating for variation in the electrical characteristics of the pixel. Sensing accuracy may be improved by accumulating the sensing current at an integrator before converting into the sensing data. Accordingly, display quality of the display panel may be improved.

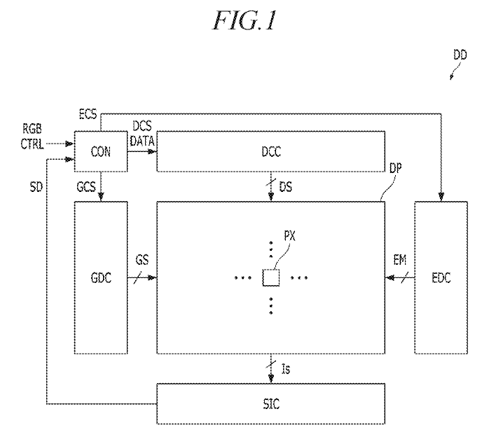

FIG. 1 illustrates a block diagram of a display device DD according to one embodiment of the present disclosure. Referring to FIG. 1, the display device DD includes a display panel DP, a scan driving circuit GDC, a light-emission driving circuit EDC, a data driving circuit DCC, a sensing circuit SIC, and a driving controller CON. The display device DD is not limited to that illustrated in FIG. 1, and may further include additional elements. For example, the display device DD may further include a voltage generator configured to generate voltages necessary for operating elements included in the display panel DP.

The display panel DP includes a plurality of pixels PX. Each of the plurality of pixels PX may be configured to emit light. The plurality of pixels PX may be arranged along rows and columns in a two-dimensional matrix. The plurality of pixels PX of the display panel DP may be electrically connected to the scan driving circuit GDC through a plurality of scan lines and to the light-emission driving circuit EDC through a plurality of light-emission control lines. In addition, the plurality of pixels PX of the display panel DP may be electrically connected to the driving circuit DCC through a plurality of data lines, and may be electrically connected to the sensing circuit SIC through a plurality of sensing lines.

Although it is not illustrated in FIG. 1, the display panel DP may include a plurality of pixel blocks in which a plurality of pixels PX are grouped therein. The sensing circuit SIC may perform a sensing operation on a target pixel included in each of the plurality of pixel blocks. The plurality of pixel blocks are arranged along row and column directions. Each of the plurality of pixel blocks may include a plurality of pixel rows arranged along the row direction. Among the plurality of pixel rows, a pixel row including the target pixel may be referred to as a target pixel row. The size of each pixel block may be defined according to a number of pixels PX included therein. A detailed description of the pixel block will be provided later.

The driving controller CON may be configured to receive an image signal RGB, and a control signal CTRL from an external device, and may receive sensing data SD from the sensing circuit SIC. In one embodiment, the image signal RGB and the control signal CTRL may be provided from an application processor (not shown). The image signal RGB will be understood as a graphic source of an image to be displayed in the display panel DP. The control signal CTRL may include a synchronization signal for synchronizing the output of an image at an accurate location.

The sensing data SD may be provided from the sensing circuit SIC. The sensing data SD may represent electrical characteristics of the plurality of pixels PX. In one embodiment, the sensing data SD may include sensing voltage information which is generated based on sensing current (Is) information of the plurality of pixels PX. Accordingly, based on the sensing data SD, the driving controller CON may calculate variations in a luminance value across the display panel DP as well as a current magnitude and a threshold voltage of a driving transistor of the pixel PX. As a result, the driving controller CON may compensate for those variations by adjusting value of data signal transmitted to the data driving circuit DCC.

Since heat generated in the display panel DP tends to diffuse to surrounding areas, electrical characteristics of a pixel PX may be similar to those of adjacent pixels PX. Accordingly, the sensing data SD need not include electrical characteristics for all pixels PX included in the display panel DP, but may include electrical characteristics for a portion of pixels PX (i.e., target pixels) included in the plurality of pixel blocks.

The driving controller CON may be configured to compensate for variations in electrical characteristics of the plurality of pixels PX based on the sensing data SD. The characteristic variations among the pixels PX may include threshold voltage variations and mobility variations of the driving transistors, which are affected by ambient temperature or by internal heat generated in the display device DD. The image signal RGB may be compensated based on the sensing data SD through the driving controller CON. The present disclosure is not limited to that described above, and the image signal RGB may be compensated based on the sensing data SD by an application processor (not shown).

The driving controller CON is configured to generate data DATA by converting the data format of the image signal RGB to comply with interface specifications associated with the data driving circuit DCC. Based on the control signal CTRL, the driving controller CON may be configured to generate a scan control signal GCS to control the scan driving circuit GDC, a light-emission driving control signal ECS to control the light-emission driving circuit EDC, and a data control signal DCS to control the data driving circuit DCC. Although not illustrated in FIG. 1, the driving controller CON may also be configured to generate a signal for controlling the sensing circuit SIC.

The data driving circuit DCC is configured to receive the data control signal DCS and the data DATA from the driving controller CON. The data driving circuit DCC may be configured to convert the data DATA, which is a digital signal, into data signals DS, which are analog signals. The data signals DS are converted to correspond to a gray value of the data DATA. The data driving circuit DCC may be configured to output the converted data signals DS to the plurality of pixels PX through a plurality of data lines.

The data DATA received by the data driving circuit DCC may include image data and pattern data. The data driving circuit DCC may be configured to operate on a fame-by-frame basis. The data driving circuit DCC may be configured to output data signals DS having gray value voltages corresponding to the image data to the plurality of pixels PX during an active period for displaying an image. Accordingly, the plurality of pixels PX may be configured to emit light based on the data signals DS corresponding to the image data.

The data driving circuit DCC may be configured to output the data signals DS having gray value voltages corresponding to the pattern data to the plurality of pixels PX during the blank period subsequent to the active period. The pattern data may include data having a black gray value and a non-black gray value. In one embodiment of the present disclosure, the data signal DS corresponding to the pattern data having the black gray value may have the lowest voltage among voltages that the data signals DS may have. When the data signal DS corresponding to the pattern data having the gray value is applied to the pixel PX, sensing data SD may be generated from the sensing circuit SIC. Accordingly, the plurality of pixels PX may not emit light during the blank period and generate a sensing current Is based on the data signals DS corresponding to the pattern data.

The scan driving circuit GDC may be configured to receive a scan control signal GCS from the driving controller CON. The scan driving circuit GDC may be configured to output scan signals GS to scan lines based on the scan control signal GCS. The scan driving circuit GDC may be configured to sequentially activate the plurality of pixels PX on a row-by-row basis using the scan signals GS. Hereinafter, the term “activation” refers to a state in which the plurality of pixels PX may receive the data signals DS through the data lines.

The light-emission driving circuit EDC may be configured to receive a light-emission driving control signal ECS from the driving controller CON. The light-emission driving circuit EDC may be configured to output light-emission signals EM to the plurality of pixels PX through light-emission control lines in response to the light-emission driving control signal ECS. The light-emission driving circuit EDC may be configured to sequentially enable the plurality of pixels PX to emit light on a row-by-row basis using the light-emission signals EM.

The sensing circuit SIC may be configured to receive sensing currents Is from the plurality of pixels PX disposed on the display panel DP. The sensing circuit SIC may be configured to generate sensing data SD based on the sensing currents Is. The present disclosure is not limited to the foregoing description, and the sensing circuit SIC may be configured to receive sensing voltages rather than the sensing currents Is. The sensing circuit SIC may be configured to calculate sensing currents Is of the pixels PX based on the sensing voltages. The sensing circuit SIC may be configured to generate sensing data SD based on the sensing currents Is calculated from the sensing voltages, and output sensing data SD to the driving controller CON.

In addition, as described above, the sensing circuit SIC may be configured to generate sensing data SD for each of the plurality of pixel blocks. Accordingly, the sensing circuit SIC may be configured to generate sensing data SD corresponding to each position of the plurality of pixel blocks in the display panel DP.

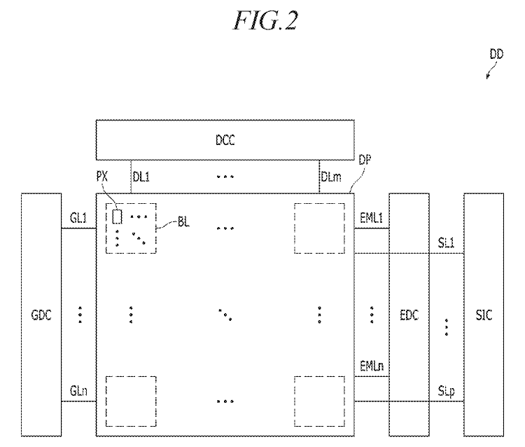

FIG. 2 illustrates a connection structure of the display panel and the driving circuits shown in FIG. 1. The display device DD may include a plurality of data lines DL1 through DLm, a plurality of scan lines GL1 through GLn, a plurality of light-emission control lines EML1 through EMLn, and a plurality of sensing lines SL1 through SLp. The display panel DP may include a plurality of pixel blocks BL defined therein, and the pixel blocks BL may be configured as groups of a plurality of pixels PX. The plurality of pixel blocks BL may be arranged along row and column directions.

The data driving circuit DCC is connected to pixels PX arranged in the row direction through a first to m-th data lines DL1 through DLm. The scan driving circuit GDC is connected to pixels PX arranged in the column direction through a first to n-th scan lines GL1 through GLn. The light-emission driving circuit EDC is connected to pixels PX arranged in the column direction through a first to n-th light-emission control lines EML1 through EMLn. The sensing circuit SIC is connected to pixels PX arranged in the column direction through a first to p-th sensing lines SL1 through SLp.

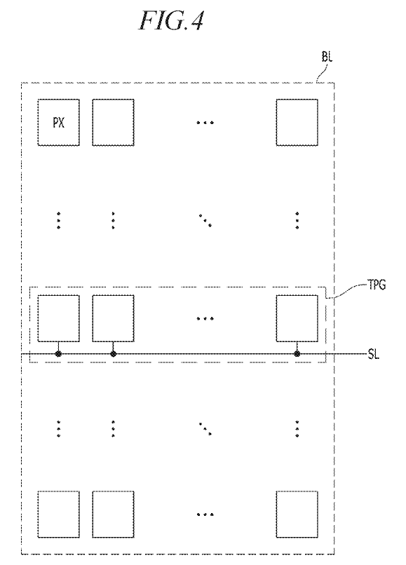

In one embodiment of the present disclosure, the display panel DP may include a first group of pixels PX connected to a scan line GL, a data line DL, a light-emission control line EML, and a sensing line SL. A pixel row including the first group of pixels PX may be referred to as a target pixel row. A pixel selected among the first group of pixels PX for sensing operation may be referred to a target pixel. In addition, the display panel DP may include a second group of pixels PX connected to the scan line GL, the data line DL, and the light-emission control line EML, but not to the sensing line SL. Pixel rows including the second group of pixels PX may be referred to as non-target pixel rows. Accordingly, the number p, representing the number of the sensing lines SL, may be less than the number n, representing the number of the scan lines GL. The configuration of the plurality of sensing lines SL1 through SLp will be described with reference to FIG. 4.

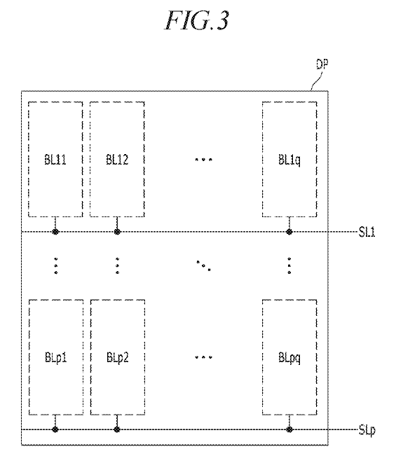

FIG. 3 is an exemplary block diagram of the display panel DP shown in FIG. 2. As described above, the display panel DP may include a plurality of pixel blocks BL11 through BLpq defined therein. Although it is not illustrated in FIG. 3, the plurality of pixel blocks BL11 through BLpq may be configured as groups of a plurality of pixels PX, and the plurality of pixels PX may be disposed in each of pixel blocks BL11 through BLpq.

A size of the pixel block BL may be determined based on a resolution of the display device DD and an arrangement structure of the pixels PX. For example, one pixel block BL may include 128 scan lines GL, 128 data lines DL, and 16,384 pixels PX disposed therein.

In one embodiment of the present disclosure, a single sensing line SL may be connected to a row of the plurality pixel blocks BL11 through BLpq. Accordingly, the number p, representing the number of the sensing line SL, may be equal to the number of rows of the pixel blocks BL11 through BLpq.

FIG. 4 illustrates a pixel block BL shown in FIG. 3. The pixel block BL may include one target pixel row TPG connected to the sensing line SL. Accordingly, a plurality of pixel rows other than the target pixel row TPG (i.e., non-target pixel rows) in the pixel block BL may not be connected to the sensing line SL. As described above, as heat generated in the display panel DP diffuses to surrounding areas, the sensing data detected through the sensing line SL connected to the target pixel row TPG, rather than to all pixel rows, may represent electrical characteristics of the pixel block BL. As a result, as a sensing operation may be performed only on the target pixel row TPG representing each pixel block BL, overall sensing time may be reduced.

Referring to FIG. 4, the sensing line SL may be connected to a pixel row disposed at the center of the pixel block BL. For example, a number of pixel rows disposed above the target pixel row TPG may be the same as or similar to the number of pixel rows disposed below the target pixel row TPG. A position of the target pixel row TPG is not limited to the foregoing description.

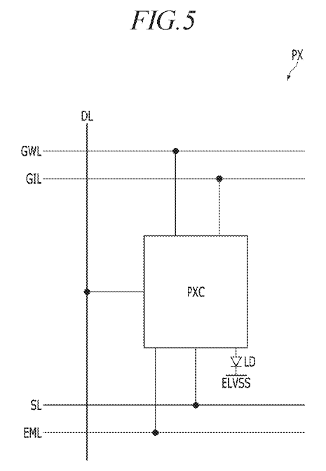

FIG. 5 illustrates an exemplary pixel PX according to one embodiment of the present disclosure. Referring to FIG. 5, the pixel PX may include a pixel circuit PXC, and a light emitting diode LD. An anode electrode of the light-emitting diode LD may be connected to a first driving voltage through the pixel circuit PXC, and a cathode electrode of the light-emitting diode LD may be connected to a second driving voltage ELVSS.

The pixel circuit PXC may be electrically connected to a plurality of signal lines, such as a data line DL, a gate write line GWL, a gate initialization line GIL, a light-emission control line EML, and a sensing line SL. The pixel circuit PXC may be configured to control a light-emitting diode LD based on signals received through the plurality of signal lines DL, GWL, GIL, EML, and SL. However, the signal lines are not limited to the foregoing, and the pixel circuit PXC may further include additional signal lines.

A light-emitting diode LD may be composed of an organic light-emitting diode or an inorganic light-emitting diode, such as a quantum dot light-emitting diode. Alternatively, the light-emitting diode LD may be composed of a combination of an organic material and an inorganic material.

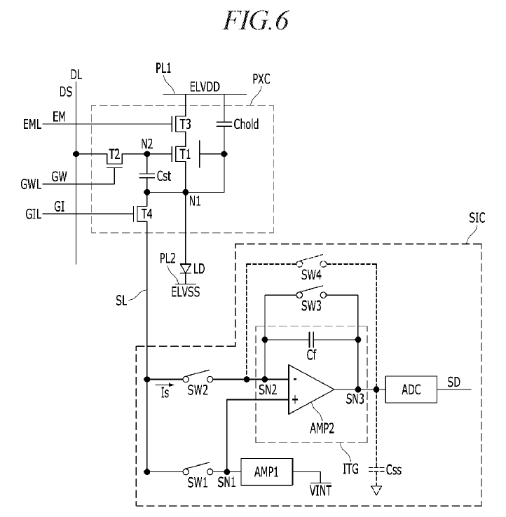

FIG. 6 illustrates an exemplary transistor-level implementation of a pixel circuit PXC and a sensing circuit SIC according to one embodiment of the present disclosure. Referring to FIG. 6, the pixel PX (see FIG. 5) may include a pixel circuit PXC and a light-emitting diode LD and be connected to a sensing circuit SIC through a sensing line SL.

The pixel circuit PXC may be configured to receive a data signal DS through the data line DL. In addition, the pixel circuit PXC may be configured to receive a gate writing signal GW, a gate initialization signal GI, and a light-emission signal EM respectively from the gate writing line GWL, the gate initialization line GIL, and the light-emission control line EML.

The pixel circuit PXC may be configured to receive a first driving voltage ELVDD and a second driving voltage ELVSS. The pixel circuit PXC may be further configured to control an amount of current flowing from the first driving voltage ELVDD to the second driving voltage ELVSS through the light-emitting diode LD based on the data signal DS corresponding to the image data. Accordingly, the first driving voltage ELVDD may be set higher than the second driving voltage ELVSS.

In addition, the pixel circuit PXC may be configured to receive a reference voltage VINT through the sensing line SL. Although it is not illustrated in the drawings, an electric power control circuit of the display device DD (see FIG. 1) may provide a voltage from which the first driving voltage ELVDD and the second driving voltage ELVSS are generated.

The pixel circuit PXC may include a first through fourth transistors T1 through T4, a first capacitor Cst, and a second capacitor Chold. The configuration of the pixel circuit PXC is not limited to that illustrated in FIG. 6 and may be implemented in various forms to drive the light-emitting diode LD to emit light.

Each of the first through fourth transistors T1 through T4 may include a semiconductor layer formed of at least one of oxide semiconductor and low-temperature polycrystalline silicon (LTPS).

The first transistor T1 may include a first electrode electrically connected to the first driving voltage line PL1 through the third transistor T3, a second electrode electrically connected to the anode electrode of the light-emitting diode LD, and a gate electrode connected to a second electrode of the second transistor T2. The first transistor T1 may be configured to receive the data signal DS transferred from the data line DL when the second transistor T2 is turned on to supply a driving current to the light-emitting diode LD. The first transistor T1 may include a body electrode electrically connected to the second electrode of the first transistor T1. The first transistor T1 may operate as a driving transistor of the pixel PX.

The second transistor T2 may include a first electrode connected to the data line DL, a second electrode connected to the gate electrode of the first transistor T1, and a gate electrode connected to the gate writing line GWL. The second transistor T2 may be turned on in response to the gate writing signal GW transferred through the gate writing line GWL, thereby transferring the data signal DS provided from the data line DL to the gate electrode of the first transistor T1.

The third transistor T3 includes a first electrode connected to the first driving voltage line PL1 and a second electrode connected to the first electrode of the first transistor T1, and a gate electrode connected to the light-emission control line EML. The third transistor T3 may be turned on in response to the light-emission signal EM transferred through the light-emission control line EML, thereby supplying the first driving voltage ELVDD to the first transistor T1.

The fourth transistor T4 includes a first electrode connected to the second electrode of the second transistor T2 through the first capacitor Cst, a second electrode connected to the sensing circuit SIC through the sensing line SL, and a gate electrode connected to the gate initialization line GIL. The fourth transistor T4 may be turned on in response to the gate initialization signal GI transferred through the gate initialization line GIL, thereby either receiving the reference voltage VINT through the sensing line SL or transferring the sensing current Is to the sensing circuit SIC.

When the fourth transistor T4 receives the reference voltage VINT, the reference voltage VINT may be transferred to the anode electrode of the light-emitting diode LD. Accordingly, the anode electrode of the light-emitting diode LD may be initialized to the reference voltage VINT. Descriptions about the operation of the fourth transistor T4 to transfer the sensing current Is to the sensing circuit SIC will be provided later.

The second electrode, and the gate electrode of the first transistor T1 are electrically connected to a first node N1, and a second node N2, of the pixel circuit PXC, respectively. The body electrode of the first transistor T1 may be connected to the first node N1. The anode electrode of the light-emitting diode LD may be electrically connected to the first node N1.

The first capacitor Cst is electrically connected between the second node N2 and the first electrode of the fourth transistor T4 (i.e., the first node N1). For example, one end of the first capacitor Cst may be connected to the gate electrode of the first transistor T1 (i.e., the second node N2), and the other end may be connected to the first electrode of the fourth transistor T4 (i.e., the first node N1). The first capacitor Cst may be configured to store a voltage corresponding to the data voltage. An amount of current flowing through the first transistor T1 may be determined based on an amount of charge stored in the first capacitor Cst.

One end of the second capacitor Chold is connected to the first driving voltage line PL1, and the other end of the second capacitor Chold is connected to the body electrode of the first transistor T1. A voltage of the body electrode of the first transistor T1 may be stably maintained by the second capacitor Chold.

The sensing circuit SIC may include first through third switches SW1 through SW3, a current integrator ITG, an analog-to-digital converter ADC, and a reference voltage generator AMP1. In addition, in one embodiment of the present disclosure, the sensing circuit SIC may further include a fourth switch SW4 and a sensing capacitor Css. A configuration of the sensing circuit SIC is not limited to that illustrated in FIG. 6 and may be implemented in various forms for measuring the sensing current Is using the current integrator ITG.

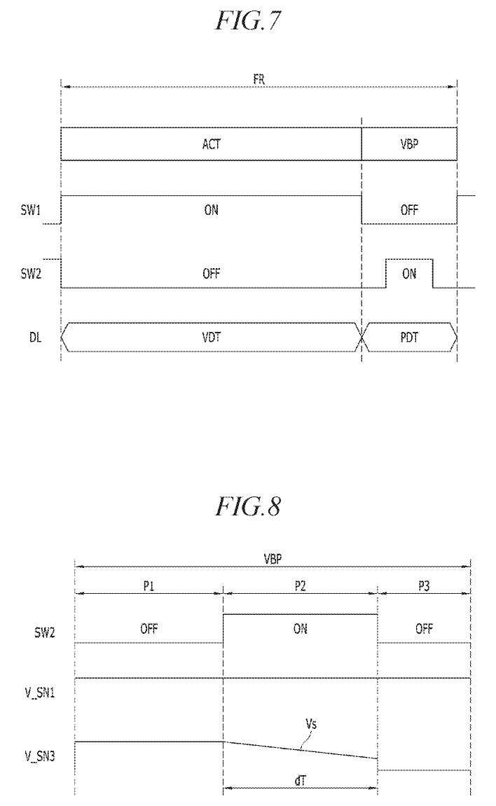

The first switch SW1 may be connected between the second electrode of the fourth transistor T4 connected to the sensing line SL and the sensing node SN1. The first sensing node SN1 may be electrically connected to the reference voltage generator AMP1. The first switch SW1 may be turned on during the active period, in which an image is displayed on the display panel DP in response to a switching control signal provided from the driving controller CON (see FIG. 1). Switch-on operations of the first switch SW1 and the second switch SW2 will be described with references to FIGS. 7 and 8.

The reference voltage generator AMP1 may be connected to one end of the first switch SW1. Accordingly, the reference voltage generator AMP1 may be configured to provide a reference voltage VINT to the pixel PX during the active period.

In a case where the pixel includes a first sub pixel configured to emit light of a first color, a second sub pixel configured to emit light of a second color, and a third sub pixel configured to emit light of a third color, the reference voltage generator AMP1 may provide reference voltages VINT of different levels to each of the plurality of sub pixels. For example, when the first color is red, the second color is blue, and the third color is green, the reference voltage VINT provided to the first sub pixel may be greater than the reference voltage VINT provided to the second sub pixel, and the reference voltage VINT provided to the second sub pixel may be greater than the reference voltage VINT provided to the third sub pixel.

The second switch SW2 may be connected between the second electrode of the fourth transistor T4 connected to the sensing line SL and the second sensing node SN2. Here, the second sensing node SN2 may be electrically connected to the current integrator ITG. The second switch SW2 may be turned on during the blank period subsequent to the active period in response to a switching control signal provided from the driving controller CON. Accordingly, during the blank period, the sensing current Is may be transferred to the current integrator ITG through the sensing line SL.

Although FIG. 6 illustrates that the first and second switches SW1, SW2 are included in the sensing circuit SIC, the arrangement of the first and second switches SW1, SW2 are not limited to that illustrated in the drawing. In another embodiment of the present disclosure, the first and second switches SW1, SW2 may be included in the pixel circuit PXC.

The current integrator ITG may be connected between the second sensing node SN2 and a third sensing node SN3. The current integrator ITG may include an amplifier AMP2 and a feedback capacitor Cf. The current integrator ITG may be configured to receive a sensing current Is of the pixel PX based on the data signal DS corresponding to the pattern data through the sensing line SL and output a sensing voltage corresponding to the sensing current Is.

The amplifier AMP2 may include a first input terminal connected to one end of the second switch SW2, a second input terminal configured to receive the reference voltage VINT, and an output terminal connected to the third sensing node SN3. The amplifier AMP2 may be configured to receive the reference voltage VINT through the reference voltage generator AMP1.

The feedback capacitor Cf may be electrically connected between the first input terminal and the output terminal of the amplifier AMP2. Accordingly, the current integrator ITG may be configured to accumulate the sensing current Is based on the reference voltage VINT to sense the current characteristics of the pixel PX. Accordingly, even when a current value per pixel PX is small due to increased resolution of the display device DD (see FIG. 1), the sensing circuit SIC may be configured to precisely measure electrical characteristics of the pixel PX by accumulating the sensing current Is using the current integrator ITG.

The third switch SW3 may be connected between the second sensing node SN2 and the third sensing node SN3. For example, the third switch SW3 and the feedback capacitor Cf may be connected in parallel. When the third switch SW3 is turned on, the feedback capacitor Cf may be initialized.

An input terminal of the analog-to-digital converter ADC may be connected to the third sensing node SN3. The analog-to-digital converter ADC may be configured to receive the sensing voltage from the current integrator ITG, and convert the sensing voltage to a digital code, thereby generating sensing data SD. The generated sensing data SD may be provided to the driving controller CON (see FIG. 1).

The fourth switch SW4 may enable the sensing circuit SIC to bypass the current integrator ITG and to measure the sensing current Is directly at the second sensing node SN2. The fourth switch SW4 may be connected between one end of the second switch SW2 (i.e., the second sensing node SN2) and one end of the sensing capacitor Css (i.e., the third sensing node SN3). Since the sensing circuit SIC measures an amount of charge accumulated in the sensing capacitor Css through the fourth switch SW4 without using the current integrator ITG, the power consumption of the sensing circuit SIC for measuring the sensing current Is may be reduced.

The sensing capacitor Css may be connected to one end of the fourth switch SW4 and the ground power. The sensing capacitor Css may be charged by the sensing current Is, and accordingly, electrical characteristics of the pixel PX may be measured through the sensing capacitor Css.

FIG. 7 is a timing diagram illustrating an operation of a sensing circuit SIC according to an embodiment. Referring to FIGS. 6 and 7, one frame FR includes an active period ACT and a blank period VBP.

During the active period ACT, the driving circuit DCC (see FIG. 1) may provide image data VDT to the pixel through the data line DL. During the active period ACT, the first switch SW1 may be turned on, and the second switch SW2 may be turned off. Accordingly, the sensing circuit SIC may provide the reference voltage VINT to the pixel. The pixel may be configured to emit light based on the data signal corresponding to the received image data VDT.

During the blank period VBP, the data driving circuit DCC may provide pattern data PDT to the pixel through the data line DL. During the blank period VBP, the first switch SW1 may be turned off, and the second switch SW2 may be turned on during certain time period within the blank period VBP. Accordingly, while the second switch SW2 is turned on, the sensing circuit SIC may receive the sensing current Is from the pixel. The pixel may transfer the sensing current Is, based on the data signal corresponding to the pattern data PDT, to the sensing circuit SIC through the sensing line SL without emitting light. Detailed descriptions of the operation of the second switch SW2 will be provided with reference to FIG. 8.

The operation of the second switch SW2 is not limited to that illustrated in FIG. 7. The second switch SW2 may be continuously turned on during the blank period VBP. The sensing circuit SIC may further include an auxiliary switch connected between the second sensing node SN2 and the third sensing node SN3, and the sensing operation may be controlled by the auxiliary switch during the blank period VBP. The auxiliary switch may be configured to sense the sensing voltage Vs at the sensing capacitor Css connected to the fourth switch SW4 rather than through the current integrator ITG.

FIG. 8 is a timing diagram illustrating an operation of a sensing circuit in a blank period VBP according to an embodiment. Referring to FIGS. 6 and 8, the blank period may include a first through third periods P1 through P3. In the first through third periods P1 through P3, a first sensing node voltage V_SN1 may be constantly maintained at the reference voltage VINT. For example, the current integrator ITG may integrate the sensing current Is based on the reference voltage VINT and reflect the result in an output voltage of the amplifier AMP2.

During the first period P1, the second switch SW2 may be turned off. Since a third sensing node voltage V_SN3 is an output voltage of the amplifier AMP2, it may be the same as or similar to the reference voltage VINT received from the reference voltage generator AMP1.

During the second period P2, the second switch SW2 may be turned on. Accordingly, the sensing current Is received through the sensing line SL may be accumulated over time at the feedback capacitor Cf of the current integrator ITG. As the sensing current is accumulated at the feedback capacitor Cf, the output voltage of the current integrator ITG gradually changes. Accordingly, the third sensing node voltage V_SN3, which is output voltage of the current integrator ITG, may change over a sensing time dT.

Electrical characteristics of a pixel may be calculated based on the sensing voltage Vs measured in the second period P2 over the sensing time dT. The electrical characteristics may be sensed by measuring a pixel current which may be measured differently due to variations in threshold voltage and/or electric charge mobility of the driving transistor of the pixel at different ambient temperature. In the second period P2, as a result of calculating electrical characteristics of the pixel, sensing data SD may be generated.

In the third period P3 subsequent to the second period P2, the second switch SW2 may be turned off, and the third switch SW3 may be turned on. Accordingly, the feedback capacitor Cf may be initialized. An output voltage of the current integrator ITG may be initialized to the reference voltage VINT.

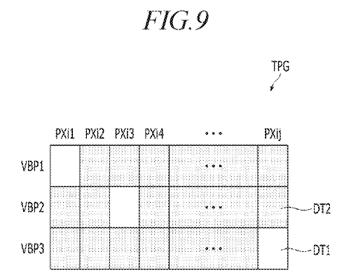

FIG. 9 illustrates pattern data PDT applied to a pixel PX during a blank period VBP according to an embodiment. Referring to FIGS. 7 and 9, the pattern data PDT in the blank period VBP may be applied to the target pixel row TPG connected to the sensing line SL. The target pixel row TPG may include at least one target pixel applied with a first data signal DT1 among the plurality of pixels PXi1 through PXij.

For example, the pattern data PDT may include the first data signal DT1 applied to the target pixel of the target pixel row TPG, and a second data signal DT2 applied to the pixels of the target pixel row TPG other than the target pixel. The first data signal DT1 may have a greater gray value than the second data signal DT2. For example, the second data signal DT2 may have a gray value representing a black color. Accordingly, the second data signal DT2 may provide a reference value for generation of the sensing data by the sensing circuit SIC.

In one embodiment of the present disclosure, the first frame may include a first active period and a first blank period VBP1, and a second frame subsequent to the first frame may include a second active period and a second blank period VBP2. A third frame subsequent to the second frame may include a third active period and a third blank period VBP3.

The target pixels of the first through third frames may be selected from a target pixel row during the first through third blank periods VBP1, VBP2, and VBP3. For example, during the first blank period VBP1, the target pixel may be a pixel PXi1 disposed in a first column location in the target pixel row. During the second blank period VBP2, the target pixel may be a pixel PXi3 disposed in a third column location in the target pixel row. During the third blank period VBP3, the target pixel may be a pixel PXij disposed in a j-th column location in the target pixel row. The number and position of target pixels to which the first data signal DT1 is applied are not limited to that illustrated in FIG. 9.

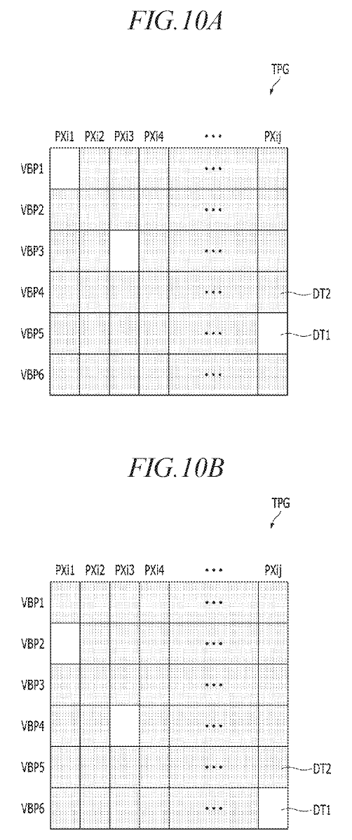

FIGS. 10A and 10B illustrate pattern data PDT applied to a pixel PX during a blank period VBP according to another embodiment. First through sixth frames may include first through sixth blank periods VBP1 through VBP6, respectively. In addition, as described above, the first data signal DT1 may have a greater gray value than the second data signal DT2.

Referring to FIG. 10A, during the first blank period VBP1, a target pixel PXi1 disposed in a target pixel row TPG may be applied with the first data signal DT1, and pixels of the target pixel row TPG other than the target pixel PXi1 may be applied with the second data signal DT2.

During the second blank period VBP2, all of the first to j-th pixels PXi1 through PXij included in the target pixel row TPG may be applied with the second data signal DT2. Accordingly, a reference value for generation of the sensing data may be measured during the second blank period VBP2.

During the third blank period VBP3, the first data signal DT1 may be applied to a target pixel PXi3 disposed in the target pixel row TPG, and pixels of the target pixel row TPG other than the target pixel PXi3 may be applied with the second data signal DT2.

During the fourth blank period VBP4, all of the first to j-th pixels PXi1 through PXij included in the target pixel row TPG may be applied with the second data signal DT2. Accordingly, a reference value for generation of sensing data may be measured during the fourth blank period VBP4.

Likewise, during the fifth blank period VBP5, pattern data including the first and second data signals DT1, DT2 may be applied to the pixels of the target pixel row in the same manner as in the first and the third blank periods VBP1, VBP3.

During the sixth blank period VBP6, pattern data including the second data signal DT2 may be applied to the pixels of the target pixel row in the same manner as in the second and the fourth blank periods VBP2, VBP4.

Referring to FIG. 10B, unlike FIG. 10A, a blank period in which the first data signal DT1 is not applied may proceed first, and a blank period in which the first data signal DT1 and the second data signal DT2 are applied may subsequently proceed.

For example, during the first, third, and fifth blank periods VBP1, VBP3, and VBP5, pattern data PDT including a second data signal DT2 may be applied to the pixels of the target pixel row TPG. A reference value for generation of sensing data may be measured during the first, third, and fifth blank periods VBP1, VBP3, and VBP5.

Pattern data PDT including both first and second data signals DT1 and DT2 may be applied during the second, fourth, and sixth blank periods VBP2, VBP4, and VBP6. The number and position of the target pixels applied with the first data signal DT1 are not limited to that illustrated in FIGS. 10A and 10B.

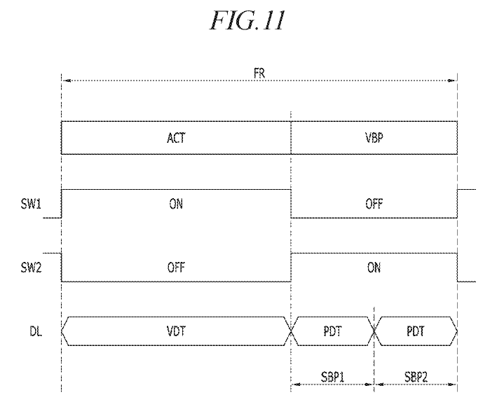

FIG. 11 is a timing diagram illustrating an operation of a sensing circuit SIC according to another embodiment. Referring to FIG. 11, unlike FIG. 7, a blank period VBP may include a first sub-period SBP1 and a second sub-period SBP2. During each of the first and second sub-periods SBP1 and SBP2, different pattern data PDT may be provided to the pixel.

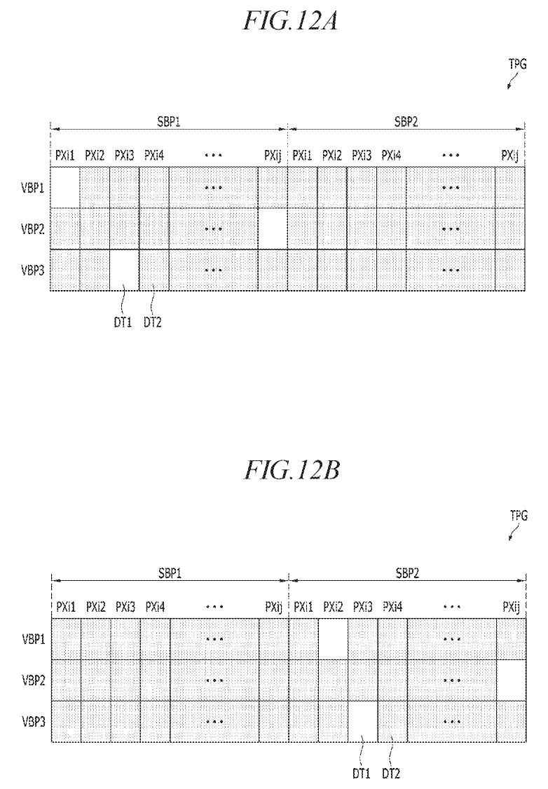

FIGS. 12A and 12B illustrate pattern data PDT applied to a pixel based on the operation of the sensing circuit SIC shown in FIG. 11. First through third frames, which proceed sequentially, may include first to third blank periods VBP1 through VBP3, respectively. In addition, as described above, the first data signal DT1 may have a greater gray value than the second data signal DT2.

Referring to FIG. 12A, during a first sub-period SBP1 of the first blank period VBP1, a target pixel PXi1 disposed in a target pixel row may be applied with the first data signal DT1. The pixels of the target pixel row TPG other than the target pixel may be applied with the second data signal DT2 during the first sub-period SBP1 of the first blank period VBP1.

During a second sub-period SBP2 of the first blank period VBP1, the second data signal DT2 may be applied to all pixels PXi1 through PXij of the target pixel row TPG. Accordingly, during the first sub-period SBP1 of the first blank period VBP1, sensing operation may be performed on the target pixel, and a reference value for sensing operation of the target pixel may be measured during the second sub-period SBP2 of the first blank period VBP1.

During a first sub-period SBP1 of the second blank period VBP2, a j-th pixel PXij of the target pixel row TPG may be a target pixel and applied with the first data signal DT1. The pixels of the target pixel row TPG other than the j-th target pixel may be applied with the second data signal DT2 during the first sub-period SBP1 of the second blank period VBP2. During a second sub-period SBP2 of the second blank period VBP2, the second data signal DT2 may be applied to first through j-th pixels PXi1 through PXij of the target pixel row TPG.

During the third blank period VBP3, the first data signal DT1 may be applied to a target pixel during a first sub-period SBP1, as in the first and second blank periods VBP1 and VBP2, and a reference value may be measured in a second sub-period SBP2.

Referring to FIG. 12B, unlike FIG. 12A, the sequence for measuring a reference value may be modified. For example, during a first sub-period SBP1, the second data DT2 may be applied to all pixels PXi1 through PXij of the target pixel row TPG to measure a reference value for generation of sensing data. During a second sub-period SBP2, the first data signal DT1 may be applied to a target pixel, and the second data signal DT2 may be applied to pixels of the target pixel row TPG other than the target pixel. The number and position of the target pixels applied with the first data signal DT1 are not limited to that illustrated in FIGS. 12A and 12B.

A display device according to one embodiment of the present disclosure may be applied to various electronic devices. An electronic device according to one embodiment may include described display devices and further include modules or devices having other additional functions in addition to the display device.

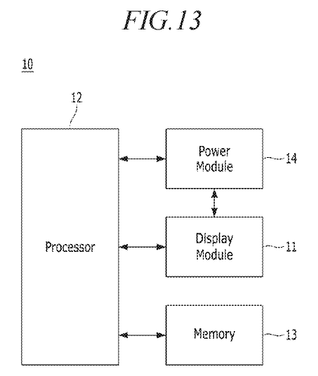

FIG. 13 is a block diagram of an electronic device to which a display device according to one embodiment of the present disclosure is applied. Referring to FIG. 13, an electronic device 10 according to one embodiment may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

Data information stored in the memory 13 may be used for operating the processor 12 or the display module 11. When the processor 12 executes an application stored in the memory 13, an image data signal and/or an input control signal may be transferred to the display module 11, which may then process the received signal/signals and output image information through a display screen.

The power module 14 may include a power supply module, such as a power adapter or a battery device, and a power conversion module configured to convert source power supplied by the power supply module to regulated power used for operating the electronic device 10.

At least one of the components of the electronic device 10 may be included in the display device according to embodiments described above. Moreover, some of the individual modules functionally included in a single module may be included in the display device, while others may be separately provided from the display device. For example, the display device may include the display module 11, whereas the processor 12, the memory 13, and the power module 14 may be provided as separate components within the electronic device 10 rather than as part of the display device.

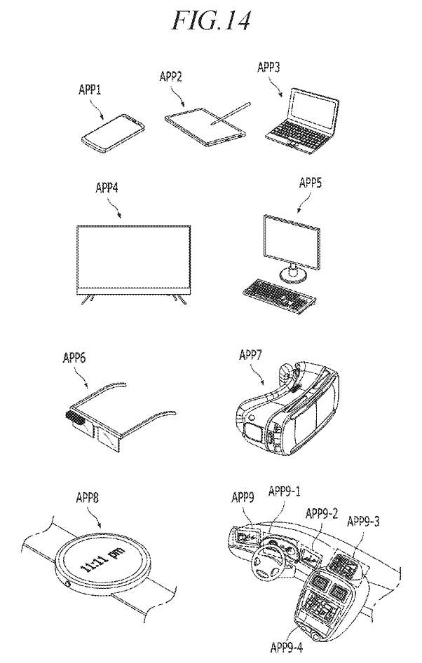

FIG. 14 illustrates electronic devices 10 according to embodiments of the present disclosure. Referring to FIG. 14, various electronic devices 10 to which the display device according to the embodiments is applied may include not only image-displaying electronic devices such as a smartphone APP1, a tablet PC APP2, a laptop computer APP3, a TV set APP4, and a desktop monitor APP5, but also wearable electronic devices including a display module, such as smart glasses APP6, a head-mounted display device APP7, and a smartwatch APP8. The display device may also be applied to automotive electronic devices APP9 through APP9-4 including a display module, such as a vehicle instrument panel, a center fascia, a dashboard-integrated center information display (CID), and a room mirror display.

Hitherto, several embodiments of the present disclosure have been described above, but these are merely exemplary and are not intended to limit the present disclosure. Those skilled in the art to which the present disclosure pertains may make various modifications and changes to the embodiments by adding, changing, deleting, or adding certain elements, without departing from the scope of the technical ideas of the present disclosure as set forth in the claims, and such modifications and changes should also be regarded as being within the scope of the present disclosure.

What is claimed is:

1. A display device comprising:
a driving controller configured to provide a data signal;
a display panel comprising a plurality of pixels connected to a scan line, a data line, and a sensing line;
a scan driving circuit configured to provide a scan signal to the plurality of pixels through the scan line;
a data driving circuit configured to generate image data based on the data signal and pattern data, and provide the image data and the pattern data to the plurality of pixels through the data line; and
a sensing circuit configured to provide a reference voltage to the plurality of pixels through the sensing line, generate sensing data by accumulating a sensing current corresponding to the pattern data based on the reference voltage, and transmit the sensing data to the driving controller,
wherein the sensing circuit comprises:
a reference voltage generator configured to provide the reference voltage to the plurality of pixels through the sensing line during an active period in which an image is displayed;
an integrator configured to receive the sensing current corresponding to the pattern data through the sensing line during a blank period subsequent to the active period, and to output a sensing voltage by accumulating the sensing current; and
an analog-to-digital converter configured to convert the sensing voltage into the sensing data.

2. The display device of claim 1, wherein the driving controller is further configured to receive the sensing data from the sensing circuit, and to adjust a value of the data signal to be transmitted to the data driving circuit based on the sensing data.

3. The display device of claim 1, wherein the sensing circuit further comprises:
a driving switch connected between the sensing line and the reference voltage generator, and configured to be turned on during the active period; and
a sensing switch connected between the sensing line and the integrator, and configured to be turned on during the blank period.

4. The display device of claim 3, wherein the integrator comprises:
an amplifier, in which a first input terminal of the amplifier is electrically connected to the sensing line, a second input terminal of the amplifier is electrically connected to the reference voltage generator and receives the reference voltage, and an output terminal of the amplifier is configured to output the sensing voltage; and
a feedback capacitor electrically connected between the first input terminal of the amplifier and the output terminal of the amplifier, and configured to convert the sensing current into the sensing voltage.

5. The display device of claim 4, wherein the sensing circuit further comprises a reset switch connected between the first input terminal of the amplifier and the output terminal of the amplifier, and the reset switch is configured to be turned on to initialize the feedback capacitor after the sensing voltage is converted into the sensing data.

6. The display device of claim 3, wherein the sensing circuit further comprises:
a sensing capacitor electrically connected between an input terminal of the analog-to-digital converter and a ground power source, and configured to accumulate the sensing current during the blank period; and
an auxiliary switch connected between the sensing switch and the sensing capacitor, and configured to be turned on to transfer the sensing current to the sensing capacitor.

7. The display device of claim 1, wherein the display panel further comprises:
a driving switch connected between the sensing line and the reference voltage generator, and configured to be turned on during the active period; and
a sensing switch connected between the sensing line and the integrator, and configured to be turned on during the blank period.

8. The display device of claim 1, wherein the plurality of pixels are arranged in a plurality of pixel blocks, each of the plurality of pixel blocks comprises a target pixel row connected to the sensing line and non-target pixel rows that are not connected to the sensing line, and a number of the sensing line is less than a number of the scan line.

9. The display device of claim 8, wherein the pattern data comprises:
a first data signal to be applied to a target pixel of the target pixel row; and
a second data signal to be applied to pixels of the target pixel row other than the target pixel,
wherein the first data signal has a greater gray value than the second data signal.

10. A display device comprising:
a plurality of first pixels connected to a scan line, a data line, and a sensing line;
a plurality of second pixels connected to the scan line and the data line, and not connected to the sensing line;
a scan driving circuit configured to provide a scan signal to the plurality of first pixels and the plurality of second pixels through the scan line;
a data driving circuit configured to provide pattern data to the plurality of first pixels and provide image data to the plurality of first pixels and the plurality of second pixels through the data line; and
a sensing circuit configured to provide a reference voltage to the plurality of first pixels through the sensing line and generate sensing data by accumulating sensing current corresponding to the pattern data based on the reference voltage,
wherein the data driving circuit is configured to operate on a frame-by-frame basis, to provide image data during an active period of each frame in which an image is displayed, and to provide pattern data during a blank period subsequent to the active period.

11. The display device of claim 10, wherein the plurality of first pixels are arranged in a target pixel row, and a target pixel is selected from the target pixel row.

12. The display device of claim 11, wherein the pattern data comprises:
a first data signal which is applied to the target pixel of the target pixel row; and
a second data signal which is applied to a plurality of first pixels of the target pixel row other than the target pixel,
wherein the first data signal has a greater gray value than the second data signal.

13. The display device of claim 12, wherein the target pixel is arranged in a different column location of the target pixel row for each blank period.

14. The display device of claim 11, wherein a first frame comprises a first active period and a first blank period, a second frame subsequent to the first frame comprises a second active period and a second blank period,
wherein the pattern data comprises:
a first data signal applied to the target pixel during the first blank period; and
a second data signal applied to the plurality of first pixels of the target pixel row other than the target pixel during the first blank period, and to the plurality of first pixels of the target pixel row including the target pixel during the second blank period, and
wherein the first data signal has a greater gray value than the second data signal.

15. The display device of claim 14, wherein a third frame subsequent to the second frame comprises a third active period and a third blank period, and a fourth frame subsequent to the third frame comprises a fourth active period and a fourth blank period,
wherein the pattern data further comprises a third data signal to be applied to a second target pixel during the third blank period, and the second data signal is applied to the plurality of first pixels other than the second target pixel during the third blank period, and to the plurality of first pixels including the second target pixel during the fourth blank period,
wherein the third data signal has a greater gray value than the second data signal, and
wherein the second target pixel selected during the third blank period is disposed in different column location of the target pixel row from a column location of the target pixel selected during the first blank period.

16. The display device of claim 11, wherein the blank period comprises a first sub-period and a second sub-period, and the pattern data comprises:
a first data signal to be applied to the target pixel during the first sub-period; and
a second data signal to be applied to the plurality of first pixels other than the target pixel during the first sub-period, and to the plurality of first pixels of the target pixel row including the target pixel during the second sub-period,
wherein the first data signal has a greater gray value than the second data signal.

17. The display device of claim 16, wherein
the second sub-period follows the first sub-period, and the target pixel is disposed in different column location of the target pixel row for each first sub-period.

18. The display device of claim 16, wherein
the first sub-period follows the second sub-period, and the target pixel is disposed in different column location of the target pixel row for each first sub-period.

19. An electronic device comprising:
a processor configured to provide an image signal and a control signal; and
a display module comprising:
a driving controller configured to receive the image signal and the control signal, and generate a data signal based on the image signal, and generate a scan control signal, a light-emission driving control signal, a data control signal, and a sensing control signal based on the control signal;
a display panel comprising a plurality of pixels connected to a scan line, a data line, and a sensing line;
a scan driving circuit configured to provide a scan signal to the plurality of pixels through the scan line in response to the scan control signal;
a data driving circuit configured to provide image data and pattern data to the plurality of pixels through the data line in response to the data control signal; and
a sensing circuit configured to provide a reference voltage to the plurality of pixels through the sensing line and generate sensing data by accumulating a sensing current corresponding to the pattern data in response to the sensing control signal,
wherein the sensing circuit comprises:
a reference voltage generator configured to provide the reference voltage to the plurality of pixels through the sensing line during an active period in which an image is displayed on the display panel;
an integrator configured to receive the sensing current corresponding to the pattern data through the sensing line during a blank period subsequent to the active period, and generate a sensing voltage based on the sensing current; and
an analog-to-digital converter configured to convert the sensing voltage into the sensing data.

20. The electronic device of claim 19, wherein the processor is further configured to receive the sensing data and adjust the image signal based on the sensing data.
